(19) United States
(12) Patent Application Publication
(10) Pub. No.: US 2005/0125706 A1
(43) Pub. Date: Jun. 9, 2005

(54) System and method for starting up plural electronic devices in an orderly manner

(75) Inventor: Ming-Huan Yuan, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/997,393

(22) Filed: Nov. 23, 2004

(30) Foreign Application Priority Data
Dec. 9, 2003 (TW) 92134647

(51) Int. Cl. G06F 1/30

(52) U.S. Cl. 713/330

(57) ABSTRACT

A system for starting up plural electronic devices in an orderly manner includes a power source and a plurality of backboards electrically connected thereto. Each backboard includes a controller for outputting a low voltage signal; a plurality of jumpers electrically connected to the controller and to ground in parallel; a switch electrically connected to the controller for controlling electrical current; and an electronic device electrically connected to the switch. The switch on each backboard is electrically connected to the power source. The controller on each backboard configures a time delay of the low voltage signal to be output, according to a combination of the states of the jumpers on the backboard. Each jumper on each backboard can be in either a disconnected state or a connected state. A related method for starting up plural electronic devices in an orderly manner is also disclosed.

### BACKGROUND OF THE INVENTION

1. Field of the Invention

The present invention relates to a system and method for starting up plural electronic devices, and particularly to a system and method for starting up plural disk drives on respective backboards in an orderly manner.

2. Description of Related Art

Generally, a computer system stores digital data in a storage device thereof. When the available capacity of the storage device is exhausted, plural storage devices can be connected to the computer system in order to enlarge the total available capacity. The storage devices can be disk drives or other kinds of storage devices known in the art.

In a typical application, a disk drive that has a driving electrical current of 2 amperes is electrically connected to a power source. When the power source is turned on, an electrical current output from the power source is transmitted to the disk drive to start up it. An initial instantaneous peak-value electrical current of the power source is equivalent to the driving electrical current of 2 amperes. Thereafter, a working electrical current of the disk drive decreases to an average value of less than 2 amperes. When few disk drives are connected to the power source, a total instantaneous peak-value electrical current is relatively low and can be easily supplied by the power source. However, when numerous disk drives are connected to the power source, the total instantaneous peak-value electrical current is correspondingly high. For example, if eight disk drives are connected to the power source, the total instantaneous peak-value electrical current required is 16 amperes if the eight disk drives are started up simultaneously. Ordinary power sources cannot supply such a strong electrical current, and a special power source must be employed in order to solve the problem. However, the purchase and running costs of such a power source are inevitably high.

Consequently, a system and method for starting up plural electronic devices in an orderly manner are needed, so as to decrease the instantaneous peak-value electrical current normally required when the plural electronic devices are start up simultaneously.

### SUMMARY OF THE INVENTION

A first object of the present invention is to provide a system for starting up plural electronic devices in an orderly manner.

A second object of the present invention is to provide a method for starting up plural electronic devices in an orderly manner.

In order to fulfill the above-mentioned first object, the present invention provides a system for starting up plural electronic devices in an orderly manner. The system includes a power source and a plurality of backboards electrically connected to it. Each of the backboards includes: a controller for outputting a low voltage signal; a plurality of jumpers electrically connected to the controller and to ground in parallel; a switch electrically connected to the controller for controlling electrical current; and an electronic device electrically connected to the switch. The switch on each of the backboards is electrically connected to the power source. The controller on each of the backboards configures a time delay of the low voltage signal to be output, according to a combination of the states of the jumpers on the backboard. Each of the jumpers on each of the backboards can be in either a disconnected state or a connected state. The electronic devices can be any of various kinds used in a particular application, and may for example include one or more disk drives.

In order to fulfill the above-mentioned second object, the present invention provides a method for starting up plural electronic devices in an orderly manner. The method includes the following steps: (a) according to a first combination of states of jumpers on a first backboard, at the moment a first time delay elapses, outputting a low voltage signal to a first switch on a first backboard to activate the first switch to be “open,” and starting up a first electronic device on the first backboard; (b) according to a subsequent combination of states of jumpers on a subsequent backboard, at the moment a subsequent time delay elapses, outputting a low voltage signal to a subsequent switch on the subsequent backboard to activate the subsequent switch to be “open,” and starting up a subsequent electronic device on the subsequent backboard; and (c) repeating step (b) for each of any further backboards and respective jumpers, switches and electronic devices thereof, at the moment each of any respective subsequent time delays elapses. The method further includes the step of outputting a high voltage signal to the switch on each of the backboards, for ensuring that the switches are each in a “closed” state before step (a).

Other objects, advantages and novel features of the present invention will become more apparent from the following detailed description when taken in conjunction with the accompanying drawings.

### BRIEF DESCRIPTION OF THE DRAWINGS

FIG. 1 is a block diagram of hardware infrastructure of an exemplary embodiment of the system according to the present invention;

FIG. 2 is a time/voltage diagram of operation of the system of the FIG. 1; and

FIG. 3 is a flow chart of an exemplary method for starting up plural disk drives in an orderly manner according to the present invention.

### DETAILED DESCRIPTION OF THE INVENTION

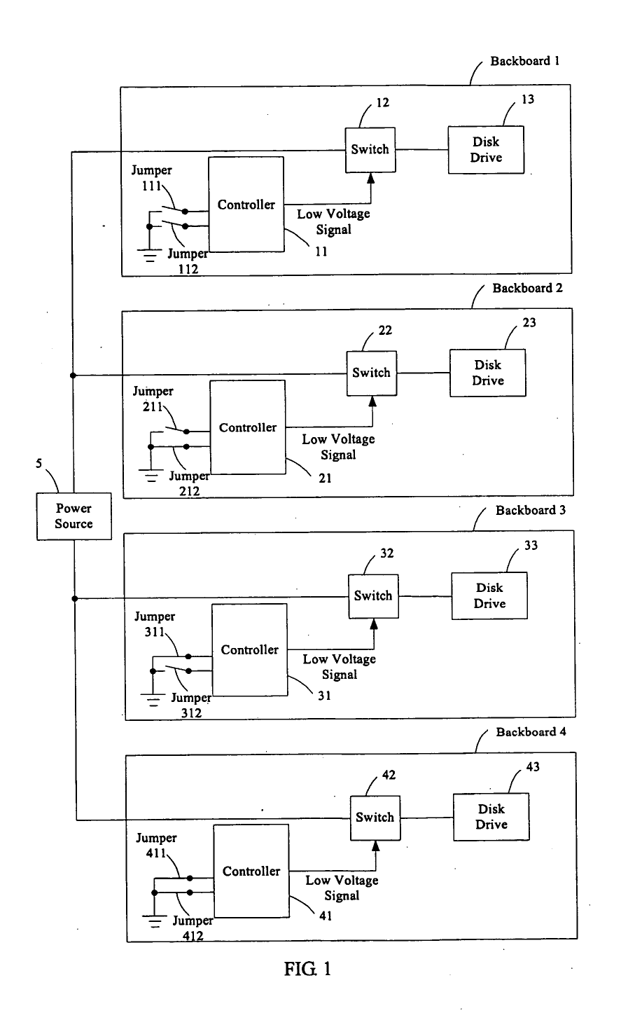

FIG. 1 is a block diagram of hardware infrastructure of the exemplary embodiment of the system for starting up plural electronic devices in an orderly manner (hereinafter, “the system”) of the present invention. In the exemplary embodiment, the system includes four backboards 1, 2, 3, 4 and a power source 5. The backboards 1, 2, 3, 4 are electrically connected to the power source 5. Each of the backboards 1, 2, 3, 4 includes a controller, two jumpers, a switch and a disk drive.

The backboard 1 includes a controller 11, two jumpers 111 and 112, a switch 12, and a disk drive 13. The controller 11 is used for outputting a low voltage signal. The jumpers 111 and 112 are electrically connected to the controller 11 and to ground in parallel. The controller 11 configures a first time delay of the low voltage signal to be output, according to the states of the jumpers 111 and 112. The switch 12 is electrically connected to the controller 11 and the power source 5 for controlling electrical current of the disk drive 13. The disk drive 13 is electrically connected to the switch 12. The state of each jumper 111 and 112 on the backboard 1 is “disconnected.”

The backboard 2 includes a controller 21, two jumpers 211 and 212, a switch 22, and a disk drive 23. The controller 21 is used for outputting a low voltage signal. The jumpers 211 and 212 are electrically connected to the controller 21 and to ground in parallel. The controller 21 configures a second time delay of the low voltage signal to be output, according to the states of the jumpers 211 and 212. The switch 22 is electrically connected to the controller 21 and the power source 5 for controlling electrical current of the disk drive 23. The disk drive 23 is electrically connected to the switch 22. The state of the jumper 211 on the backboard 2 is “disconnected,” and the state of the jumper 212 on the backboard 2 is “connected.”

The backboard 3 includes a controller 31, two jumpers 311 and 312, a switch 32, and a disk drive 33. The controller 31 is used for outputting a low voltage signal. The jumpers 311 and 312 are electrically connected to the controller 31 and to ground in parallel. The controller 31 configures a third time delay of the low voltage signal to be output, according to the states of the jumpers 311 and 312. The switch 32 is electrically connected to the controller 31 and the power source 5 for controlling electrical current of the disk drive 33. The disk drive 33 is electrically connected to the switch 32. The state of the jumper 311 on the backboard 3 is “connected,” and the state of the jumper 312 on the backboard 3 is “disconnected.”

The backboard 4 includes a controller 41, two jumpers 411 and 412, a switch 42, and a disk drive 43. The controller 41 is used for outputting a low voltage signal. The jumpers 411 and 412 are electrically connected to the controller 41 and to ground in parallel. The controller 41 configures a fourth time delay of the low voltage signal to be output, according to the states of the jumpers 411 and 412. The switch 42 is electrically connected to the controller 41 and the power source 5 for controlling electrical current of the disk drive 43. The disk drive 43 is electrically connected to the switch 42. The state of each jumper 411 and 412 on the backboard 4 is “connected.”

As described above, the system of the exemplary embodiment includes only four disk drives 1, 2, 3, 4. In other embodiments, the system can include more disk drives according to particular requirements. In such cases, the system has more backboards. For example, the system may have eight backboards. However, the more disk drives there are, the longer the time needed for starting up the disk drives in an orderly manner. Generally, the system must start up all disk drives within a given time, which limits the maximum number of disk drives. Additionally, the power source can only supply electrical power to a limited number of disk drives. That is, the power source is also a factor which limits the maximum number of disk drives.

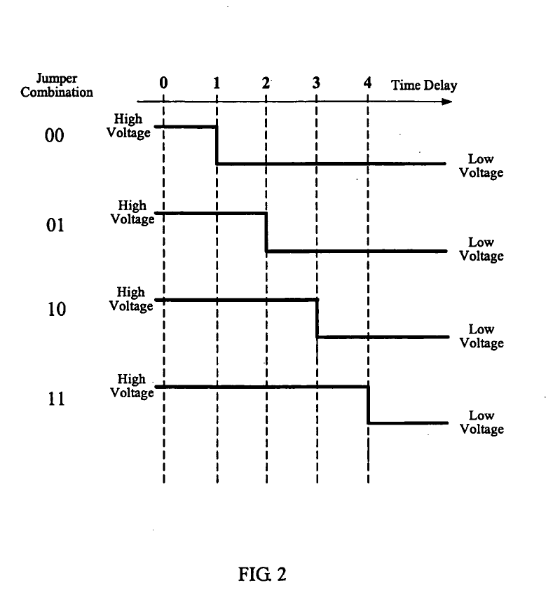

FIG. 2 is a time/voltage diagram of operation of the system. A “disconnected” state and a “connected” state of each of the jumpers on each of the backboards are represented by two opposite signals. In the exemplary embodiment of the invention, a “disconnected” state of each jumper is represented by a signal “0,” and a “connected” state of each jumper is represented by a signal “1.” Therefore a combination of the states of the two jumpers on each of the backboards is represented by a two-digit binary sequence. For example, if both jumpers on the backboard are “disconnected,” the combination of the states of the jumpers is represented as “00.” If both jumpers on the backboard are “connected,” the combination of the states of the jumpers is represented as “11.”

The state of the jumpers 111 and 112 on the backboard 1 are both “disconnected,” therefore the combination of the states of the jumpers 111 and 112 is represented as “00.” This determines the first time delay of starting up the disk drive 13, which is equivalent to one predefined time unit. The state of the jumper 211 on the backboard 2 is “disconnected,” and the state of the jumper 212 on the backboard 2 is “connected,” therefore the combination of the states of the jumpers 211 and 212 is represented as “01.” This determines the second time delay of starting up the disk drive 23, which is equivalent to two time units. The state of the jumper 311 on the backboard 3 is “connected,” and the state of the jumper 312 on the backboard 3 is “disconnected,” therefore the combination of the states of the jumpers 311 and 312 is represented as “10.” This determines the third time delay of starting up the disk drive 33, which is equivalent to three time units. The states of the jumpers 411 and 412 on the backboard 4 are both “connected,” therefore the combination of the states of the jumpers 411 and 412 is represented as “11.” This determines the fourth time delay of starting up the disk drive 43, which is equivalent to four time units.

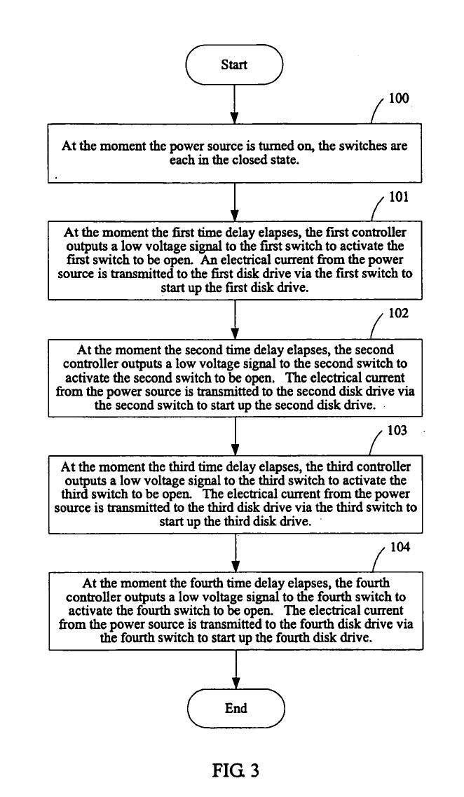

FIG. 3 is a flow chart of the exemplary method for starting up plural disk drives in an orderly manner according to the present invention. In step 100, when the power source 5 is turned on, high voltage signals output from the controllers 11, 21, 31, and 41 are transmitted to the switches 12, 22, 32, and 42 respectively. The high voltage signals set the switches 12, 22, 32, and 42 as each being in a “closed” state. Accordingly, no electrical current is input to the disk drives 13, 23, 33, and 43 via the switches 12, 22, 32, and 42.

In step 101, at the moment the first time delay elapses, the controller 11 outputs a low voltage signal according to the combination of the states of the jumpers 111 and 112. The low voltage signal is transmitted to the switch 12 to activate the switch 12 to be “open.” As a result, an electrical current from the power source 5 is transmitted to the disk drive 13 via the switch 12 to start up the disk drive 13. The switches 22, 32 and 42 are each still in the “closed” state.

In step 102, at the moment the second time delay elapses, the controller 21 outputs a low voltage signal according to the combination of the states of the jumpers 211 and 212. The low voltage signal is transmitted to the switch 22 to activate the switch 22 to be “open.” As a result, the electrical current from the power source 5 is transmitted to the disk drive 23 via the switch 22 to start up the disk drive 23. The switches 32 and 42 are each still in the “closed” state.

In step 103, at the moment the third time delay elapses, the controller 31 outputs a low voltage signal according to the combination of the states of the jumpers 311 and 312. The low voltage signal is transmitted to the switch 32 to activate the switch 32 to be “open.” As a result, the electrical current from the power source 5 is transmitted to the disk drive 33 via the switch 32 to start up the disk drive 33. The switch 42 is still in the “closed” state.

In step 104, at the moment the fourth time delay elapses, the controller 41 outputs a low voltage signal according to the combination of the states of the jumpers 411 and 412. The low voltage signal is transmitted to the switch 42 to activate the switch 42 to be “open.” As a result, the electrical current from the power source 5 is transmitted to the disk drive 43 via the switch 42 to start up the disk drive 43.

Further, while an exemplary embodiment and method of the present invention have been described above, it should be understood that they have been presented by way of example only and not by way of limitation. Thus the breadth and scope of the present invention should not be limited by the above-described exemplary embodiment and method, but should be defined only in accordance with the following claims and their equivalents.

1. A system for starting up plural electronic devices in an orderly manner, the system including a plurality of backboards, each of the backboards including:
a controller for outputting a low voltage signal;
a plurality of jumpers electrically connected to the controller and to ground in parallel;
a switch electrically connected to the controller for controlling electrical current; and
an electronic device electrically connected to the switch.

2. The system of claim 1, further including a power source, wherein the switch on each of the backboards is electrically connected to the power source.

3. The system of claim 1, wherein the controller on each of the backboards configures a time delay of the low voltage signal to be output, according to a combination of the states of the jumpers on each of the backboards.

4. The system of claim 3, wherein each of the jumpers on each of the backboards can be in either a disconnected state or a connected state.

5. The system of claim 1, wherein the electronic device on each of the backboards is a disk drive.

6. The system of claim 1, wherein at the moment the power source is turned on, the controller on each of the backboards outputs a high voltage signal to the switch on each of the backboards, for ensuring that the switches are each in a “closed” state.

7. The system of claim 6, wherein at the moment a first time delay elapses, a first controller on a first one of the backboards outputs a low voltage signal to a first switch on the first backboard to activate the first switch to be “open,” and an electrical current output from the power source starts up a first electronic device on the first backboard.

8. The system of claim 7, wherein at the moment a subsequent time delay elapses, a subsequent controller of a subsequent one of the backboards outputs a low voltage signal to a subsequent switch on the subsequent backboard to activate the subsequent switch to be “open,” and the electrical current output from the power source starts up a subsequent electronic device on the subsequent backboard.

9. A method for starting up plural electronic devices in an orderly manner, the method including the following steps:
(a) according to a first combination of states of jumpers on a first backboard, at the moment a first time delay elapses, outputting a low voltage signal to a first switch on the first backboard to activate the first switch to be “open,” and starting up a first electronic device on the first backboard;
(b) according to a subsequent combination of states of jumpers on a subsequent backboard, at the moment a subsequent time delay elapses, outputting a low voltage signal to a subsequent switch on the subsequent backboard to activate the subsequent switch to be “open,” and starting up a subsequent electronic device on the subsequent backboard; and
(c) repeating step (b) for each of any further backboards and respective jumpers, switches and electronic devices thereof, at the moment each of any respective subsequent time delays elapses.

10. The method of claim 9, further including the step of outputting a high voltage signal to the switch on each of the backboards, for ensuring that the switches are each in a “closed” state before step (a).

11. A method for starting up plural electronic devices in a predetermined order, comprising the following steps:
providing a jumper-manipulated controller electrically connected to a power switch of each of said plural electronic devices;
adjusting said controller to have a unique jumper arrangement different from other controllers; and
providing a signal from said controller to control said power switch in a predetermined time-delay manner corresponding to said jumper arrangement in order to start up said each of said plural electronic devices in said predetermined order.

12. The method of claim 11, wherein a prior one of said plural electronic devices in said predetermined order has a shorter time delay to start up than the rest thereof in said predetermined order.
